(19) United States
(12) Patent Application Publication
(10) Pub. No.: US 2026/0296853 A1
(43) Pub. Date: Oct. 1, 2026

(54) FORKLIFTS, READER ASSEMBLY FOR FORKLIFTS, AND WAREHOUSE STORAGE SYSTEM THEREOF

(71) Applicant: HCL Technologies Limited, New Delhi (IN)

(72) Inventor: Pankaj Gupta, Redmond, WA (US)

(21) Appl. No.: 19/090,518

(22) Filed: Mar. 26, 2025

(51) Int. Cl. B66F 9/075; B65G 1/137

(52) U.S. Cl. CPC B66F 9/07504; B65G 1/1375

(57) ABSTRACT

This disclosure related to a forklift. The forklift includes a forklift mast. The forklift includes a carriage assembly affixed to a first surface of the forklift mast. The forklift further includes a reader assembly affixed to a second surface of carriage assembly. The reader assembly includes a cavity positioned on a third surface of reader assembly; one or more tag readers detachably placed within cavity; a control unit. The control unit may be configured to receive information associated with a first passive tag from one or more tag readers; receive information associated with a second passive tag from one or more tag readers; receive information associated with a third passive tag from one or more tag readers; detect a current location of the object in the warehouse based on the received information associated with each of the first passive tag, the second passive tag, and the third passive tag.

### DESCRIPTION

### Technical Field

This disclosure relates generally to warehouse storage management, and more particularly to forklifts, reader assembly for forklifts, and warehouse storage system.

### Background

With the emergence of smart manufacturing the demand for intelligent warehouses and intelligent logistics systems has been increasing. A well-functioning logistics warehouse system often enhances work efficiency of workers and operational efficiency of goods. In past decades, the warehouse operations relied heavily on manual methods to track inventory and manage logistics. The manual methods have several limitations such as inefficiency, human error, lack of scalability, cost, and the like.

With the advancement in technology, various forklifts along with tag readers have been developed for storing and detecting current location of an object in the warehouse. The existing forklifts may use large (or weighted) tag readers. Additionally, the existing forklifts may use wires (e.g., Power Over Ethernet (POE) cables) to connect the tag reader with the forklift. However, there is always an issue with long term reliability of wired connections. The existing forklifts may use ultrasonic based battery-operated tags and readers for tracking approximate location of a pallet within the warehouse. However, existing forklifts fail to track the exact location of the pallet within the warehouse.

The present invention is directed at overcoming one or more limitations stated above or any other limitations associated with the known arts.

### SUMMARY

In one embodiment, a forklift is disclosed. In one example, the forklift may include a forklift mast. The forklift mast may include a carriage assembly affixed to a first surface of the forklift mast. The carriage assembly may include one or more forks. The forklift may further include a reader assembly affixed to a second surface of the carriage assembly. The reader assembly may include a cavity positioned on a third surface of the reader assembly. The reader assembly may further include one or more tag readers detachably placed within the cavity. It should be noted that the one or more tag readers are configured to read one or more passive tags placed on a set of pre-defined locations in a warehouse. It should also be noted that a reading range of the one or more tag readers is limited to a distal end of the one or more forks. The reader assembly may further include a control unit. The control unit may be configured to receive information associated with a first passive tag from the one or more tag readers. The first passive tag is placed on an object and is mapped to a package information associated with the object. The control unit may also be configured to receive information associated with a second passive tag from the one or more tag readers. The second passive tag is placed on a floor bay associated with a plurality of storage shelves and is mapped to a bay number of the floor bay. The control unit may also be configured to receive information associated with a third passive tag from the one or more tag readers. The third passive tag is placed on a storage shelf of the plurality of storage shelves and is mapped to a shelf number of the storage shelf. The control unit may also be configured to detect a current location of the object in the warehouse based on the received information associated with each of the first passive tag, the second passive tag, and the third passive tag.

In another embodiment, a reader assembly for forklifts is disclosed. In one example, the reader assembly may include a cavity positioned on a first surface of the reader assembly. The reader assembly may further include one or more tag readers detachably placed within the cavity. It should be noted that the one or more tag readers are configured to read one or more passive tags placed on a set of pre-defined locations in a warehouse. It should also be noted that a reading range of the one or more tag readers is limited to a predefined distance. The reader assembly may further include a control unit. The control unit may be configured to receive information associated with a first passive tag from the one or more tag readers. The first passive tag is placed on an object and is mapped to a package information associated with the object. The control unit may also be configured to receive information associated with a second passive tag from the one or more tag readers. The second passive tag is placed on a floor bay associated with a plurality of storage shelves and is mapped to a bay number of the floor bay. The control unit may also be configured to receive information associated with a third passive tag from the one or more tag readers. The third passive tag is placed on a storage shelf of the plurality of storage shelves and is mapped to a shelf number of the storage shelf. The control unit may also be configured to detect a current location of the object in the warehouse based on the received information associated with each of the first passive tag, the second passive tag, and the third passive tag.

In yet another embodiment, a warehouse storage system is disclosed. In one example, the warehouse storage system may include a floor. The floor may include a plurality of floor bays. Each of the plurality of floor bays may include a plurality of racks. Each of the plurality of racks may include a plurality of storage shelves. The warehouse storage system may further include a plurality of forklifts. Each of the plurality of forklifts may include a forklift mast. The forklift mast may include a carriage assembly affixed to a first surface of the forklift mast. The carriage assembly may include one or more forks. Each of the plurality of forklifts may further include a reader assembly affixed to a second surface of the carriage assembly. The reader assembly may include a cavity positioned on a third surface of the reader assembly. The reader assembly may further include one or more tag readers detachably placed within the cavity. It should be noted that the one or more tag readers are configured to read one or more passive tags placed on a set of pre-defined locations in a warehouse. It should also be noted that a reading range of the one or more tag readers is limited to a distal end of the one or more forks. The reader assembly may further include a control unit. The control unit may be configured to receive information associated with a first passive tag from the one or more tag readers. The first passive tag is placed on an object and is mapped to a package information associated with the object. The control unit may also be configured to receive information associated with a second passive tag from the one or more tag readers. The second passive tag is placed on a floor bay associated with a plurality of the storage shelves and is mapped to a bay number of the floor bay. The control unit may also be configured to receive information associated with a third passive tag from the one or more tag readers. The third passive tag is placed on a storage shelf of the plurality of storage shelves and is mapped to a shelf number of the storage shelf. The control unit may also be configured to detect a current location of the object in the warehouse based on the received information associated with the first passive tag, the second passive tag, and the third passive tag.

In another embodiment, a method for detecting a current location of an object in a warehouse is disclosed. In one example, the method may include receiving information associated with a first passive tag from one or more tag readers. It should be noted that the one or more tag readers are configured to read the first passive tag in response to a forklift picking up an object. It should be noted that the first passive tag is placed on the object and is mapped with a package information associated with the object. The method may further include receiving information associated with a second passive tag from the one or more tag readers. It should be note that the one or more tag readers are configured to read the second passive tag in response to the forklift being within a predefined proximity from a floor bay associated with a plurality of storage shelves. It should be noted that the second passive tag is placed on the floor bay and is mapped to a bay number of the floor bay. The method may further include receiving information associated with a third passive tag from the one or more tag readers. It should be noted that the one or more tag readers are configured to read a third passive tag in response to the forklift unloading the object onto a storage shelf of the plurality of storage shelves. It should be noted that the third passive tag is placed on the storage shelf and is mapped to a shelf number of the storage shelf. The method may further include detecting a current location of the object based on the received information associated with the first passive tag, the second passive tag, and the third passive tag.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a perspective view of a forklift, in accordance with some embodiments.

FIGS. 2A-2C illustrate various perspective views of a reader assembly configured to be coupled to a forklift, in accordance with some embodiments.

FIGS. 3A and 3B illustrate a warehouse storage system, in accordance with some embodiments.

FIG. 4 illustrates a functional block diagram of a system for storing and detecting a current location of an object in a warehouse, in accordance with some embodiments.

FIG. 5 illustrates a flow diagram of an exemplary process for storing and detecting a current location of an object in a warehouse, in accordance with some embodiments.

FIG. 6 illustrates a flow diagram of an exemplary process for retrieving an object from a current location in a warehouse, in accordance with some embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

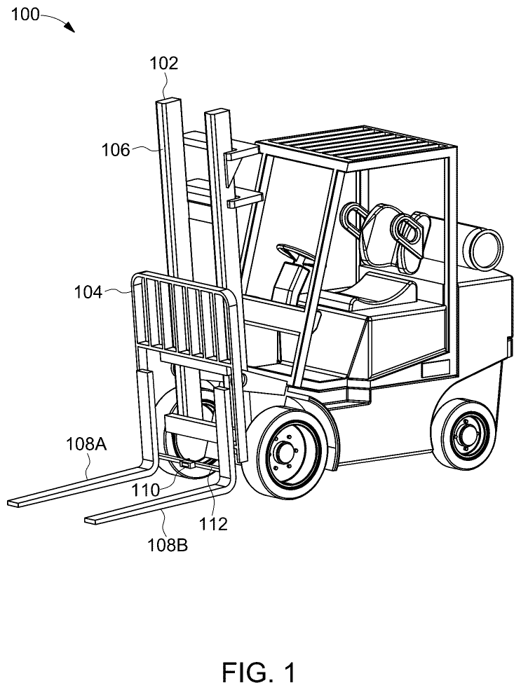

Referring now to FIG. 1, a perspective view of an exemplary forklift 100 is illustrated, in accordance with some embodiments. The forklift 100 may be configured for loading goods, carrying them, and subsequently unloading them at a desired location. The forklift 100 may also be termed as an industrial truck used to lift and move materials over short distances. The forklift 100 may include a forklift mast 102. The forklift mast 102 may include a carriage assembly 104 affixed to a first surface 106 of the forklift mast 102. As is apparent from FIG. 1, the first surface 106 may be the front surface of the forklift mast 102. By way of an example, the forklift mast 102 may provide a vertical movement to the carriage assembly 104 for lifting, tilting, or moving the goods in a warehouse. The carriage assembly 104 may include a fork 108A and a fork 108B. Each of the forks 108A and 108B may have an L-shape. By way of an example, length of each fork may vary between 2-3 feet. For ease of explanation, the carriage assembly 104 is depicted with two forks, i.e., the fork 108A and the fork 108B. However, it will be apparent that the carriage assembly 104 may include more than two forks.

By way of an example, the carriage assembly 104 may move vertically in both directions, i.e., up and down, along with the forklift mast 102 over a mast chain. The forks 108A and 108B of the carriage assembly 104 may engage with a pallet. Based on the engagement with the forks 108A and 108B, the carriage assembly 104 may hold and transport the pallet easily from one place to another within the warehouse.

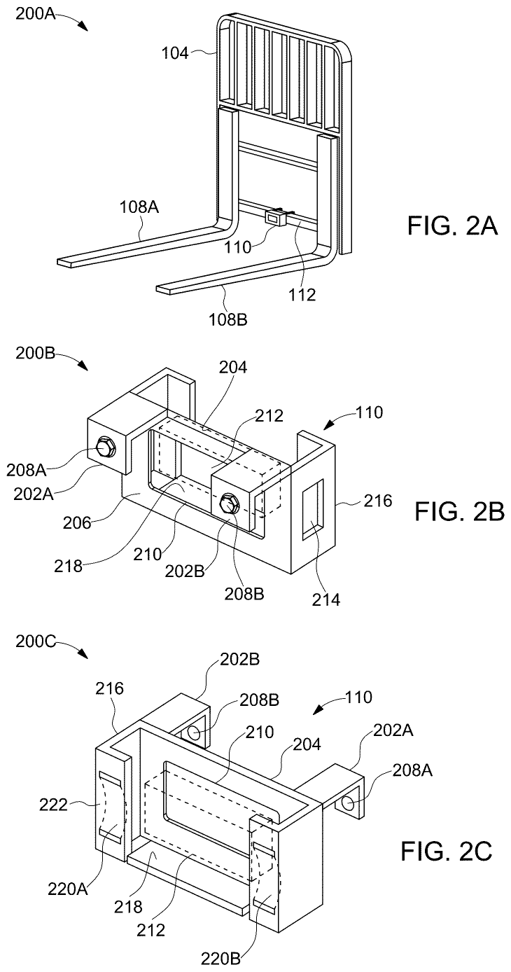

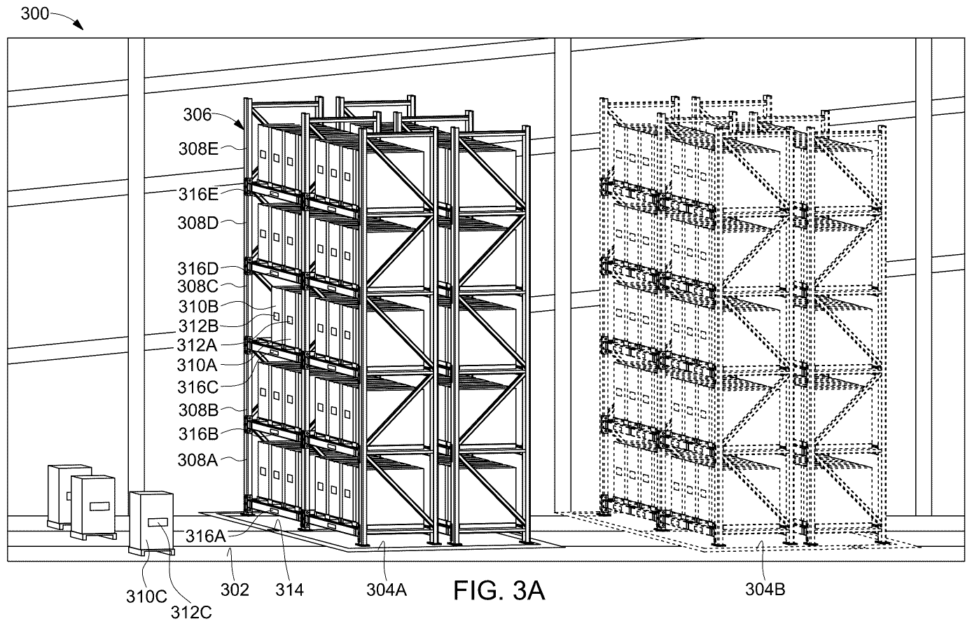

The forklift 100 may further include a reader assembly 110 affixed to a second surface 112 of the carriage assembly 104 via an attachment means. The second surface 112 may be a front surface of the carriage assembly 104 and the attachment means, for example, may include, but are not limited to, bolts, screws, clamps, Velcro, or other fasteners. The reader assembly 110 may be constructed using materials, such as, stainless steel, metal, or composite of plastic and metal, or the like. This is further explained in greater detail in conjunction with FIG. 2.

The reader assembly 110 may include a cavity (not shown) positioned on a third surface of the reader assembly 110. In particular, the cavity is made on a front surface of the reader assembly 110. The reader assembly 110 may further include one or more tag readers. The one or more tag readers, for example, may be, but are not limited to a Radio Frequency Identification (RFID) reader, an ultra-high frequency RFID (UHF RFID) reader, a barcode reader (or scanner), a Quick Response (QR) code reader, or a Near-Field Communication (NFC) reader. The one or more tag readers may be detachably placed within the cavity. In other words, the one or more tag readers may be easily placed or inserted within the cavity and subsequently removed as per the requirement. By way of an example, a UHF RFID reader may be placed (or inserted) within the cavity by a warehouse staffer. The warehouse staffer may insert the UHF RFID reader within the cavity using one or more of a sliding mechanism, a roller-based mechanism, or the like.

The one or more tag readers are configured to read one or more passive tags. The one or more passive tags are placed on a set of pre-defined locations in the warehouse. The set of pre-defined locations may include, but are not limited to a floor bay corresponding to storage shelves, one or more storage shelves, and objects placed or intended to be placed within the warehouse. The one or more passive tags may include, but are not limited to an RFID tag, a barcode tag, a QR code tag, or an NFC tag. It may be noted that a given tag reader is configured such that the reading range of the tag reader is limited to a distal end of the fork 108A and the fork 108B. In other words, the tag reader may not be able to scan any tag that is placed beyond the distal end of the forks 108A and 108B. By way of an example, length of the forks 108A and 108B may be 3 feet. In such case, the reading range of the tag reader may also be configured not to go beyond 3 feet distance. Thus, in some embodiments, the reading range of the one or more tag readers may vary based on the length of the one or more forks.

The reader assembly 110 may further include a control unit (not shown). The control unit may be configured to receive information associated with a first passive tag from the one or more tag readers. The first passive tag may be placed on an object. The object may either be a pallet or a package placed on the pallet. It will be apparent that the pallet is a flat structure (or platform) that may be configured for shipping and logistics to stack, store, and transport goods. The pallet may be made using materials, such as, wood, plastic, metal, cardboard, or the like.

In some embodiments, the first passive tag may be placed on the pallet. The pallet may include one or more fork pockets (e.g., two fork pockets). The one or more fork pockets may be positioned at a base of the pallet for insertion of the one or more forks (i.e., the fork 108A and the fork 108B). It may be apparent that the one or more fork pockets may run through the length or breadth of the pallet. In some other embodiments, the first passive tag may be affixed to the package placed on the pallet. The package may be affixed to the pallet using rope, net, stretch wrap, adhesive pallet pad, or the like. When the first passive tag is affixed to the package placed on the pallet, it may be placed on one of the surfaces of the package that may face the forklift 100 engaging with the one or more fork pockets of the pallet.

The first passive tag may be mapped to a package information associated with the object. The package information may include, but is not limited to name, contents, manufacturing date, expiry date, delivery date, net weight, or the like associated with a product contained in the package. It should be noted that each of the one or more passive tags may have a unique ID. The unique ID associated with the first passive tag may include a first alphanumeric code that is uniquely linked with objects in the warehouse. In other words, the first alphanumeric code may differentiate the first passive tag from other passive tags placed on other pre-defined locations from the set of pre-defined locations. Thus, the moment the first alphanumeric code is sensed or detected; presence of the object may be confirmed. By way of an example, when the forklift 100 is picking up a given object from a floor of the warehouse or any storage shelves, the control unit may receive the information associated with the first passive tag and may thus identify that the given object has been picked up by the forklift 100.

The control unit may also be configured to receive information associated with a second passive tag from the one or more tag readers. The second passive tag is placed on a floor bay associated with a plurality of storage shelves and is mapped to a bay number of the floor bay. The bay number, for example, may be a numeric value, an alphabetic character, or an alphanumeric value. A unique ID associated with the second passive tag may include a second alphanumeric code that is uniquely linked with floor bays in the warehouse. The second alphanumeric code may differentiate the second passive tag from other passive tags. The second alphanumeric code may indicate that the second passive tag corresponds to the floor bay associated with the plurality of storage shelves. By way of an example, when the forklift 100 is approaching one of the plurality of storage shelves to either load or unload an object, the tag reader may come within the predefined proximity (e.g., 2 to 3 feet) from the floor bay associated with the plurality of storage shelves. In such case, the control unit may receive information associated with the second passive tag affixed to the floor bay and the control unit may be able to identify that this information corresponds to a floor bay based on the second alphanumeric ID in the information.

The control unit may also be configured to receive information associated with a third passive tag from the one or more tag readers. The third passive tag may be placed on a storage shelf of the plurality of storage shelves and is mapped to a shelf number of the storage shelf. The shelf number, for example, may be a numeric value, an alphabetic character, or an alphanumeric value. A unique ID associated with the third passive tag may include a third alphanumeric code that is uniquely linked with storage shelves in the warehouse. The third alphanumeric code may differentiate the third passive tag from the other passive tags. Thus, the third alphanumeric code may indicate that the third passive tag corresponds to the storage shelves. By way of an example, when the forklift 100 is unloading the object in any storage shelf within the warehouse, the control unit may receive the information associated with the third passive tag, and the control unit may be able to identify that this information corresponds to a storage shelf based on the third alphanumeric ID in the information.

The one or more tag readers are communicatively coupled with an end device. The end device, for example, may be, but is not limited to a server, a desktop, a laptop, a notebook, a netbook, a tablet, a smartphone, a mobile phone, or any other computing device. The one or more tag readers are configured to send a notification to the end device. The notification, for example, may be one of, a text message, a voice-based message, a graphical message, a visual message, or the like. The notifications may include details of a floor bay, a rack number, and a shelf number associated with the object in the warehouse. The notification may further include package information associated with the object.

The forklift 100 may further include a charger assembly (not shown). The charger assembly is detachably fixed to a fourth surface of the carriage assembly 104. The fourth surface may be the back (or rear) surface of the carriage assembly 104. The charger assembly may include a plate. The plate may be constructed using materials, such as, metal, plastic, glass, or the like. The charger assembly may further include a wireless charger mounted on the plate. The wireless charger may be configured to charge the one or more tag readers in response to the one or more tag readers being within a predefined proximity of the wireless charger. In some embodiments, the one or more tag readers may be charged after coming into physical contact with the wireless charger. In order to enable the wireless charger to seamlessly charge the one or more tag readers, the rear surface of the reader assembly 110 may be partially or completely opened (or free from any coverage). In some embodiments, the one or more tag readers may be charged through the wireless charger, when the forklift 100 is in resting position. In some other embodiments, the one or more tag readers may be charged continuously irrespective of whether the forklift 100 is in operation or not.

Referring now to FIGS. 2A-2C , the reader assembly 110 for forklifts (such as the forklift 100) is illustrated, in accordance with some embodiments. FIG. 2A-2C are explained in conjunction with FIG. 1. In FIG. 2A, a perspective view 200A of the reader assembly 110 is illustrated, in accordance with some embodiments. The reader assembly 110 may be affixed to the front surface 112 (analogous to the second surface 112) of the carriage assembly 104 via one or more attachment means. Referring now to FIG. 2B, a rear perspective view 200B of the reader assembly 110 is illustrated, in accordance with some embodiments. The reader assembly 110 may include a clamp 202A and a clamp 202B. Each clamp, for example, may be, but is not limited to, a C-clamp, a spring clamp, a screw clamp, a locking clamp, a F-clamp, or the like. In some other embodiments, the attachment means, for example, may be, but is not limited to hook and loop fasteners, magnetic connection, inbuilt brackets (such as a U-Bracket, an angle bracket, a mounting bracket, or the like). Each clamp may be affixed to an upper edge 204 of the rear surface 206 corresponding to the reader assembly 110. In the current embodiment, each clamp may include a nut 208A and a nut 208B respectively. Each of the nuts 208A and 208B may be used to affix the reader assembly 110 to the carriage assembly 104.

The reader assembly 110 may further include a cavity 210 positioned on a first surface of the reader assembly 110. As is apparent from the FIG. 2B, the first surface may be the front surface of the reader assembly 110. The reader assembly 110 may further include a UHF RFID reader 212. The UHF RFID reader 212 may be detachably placed within the cavity 210. The reader assembly 110 may further include an opening 214. The opening 214 may be positioned at a side wall 216 of the reader assembly 110. It will be apparent that the opening 214 may be positioned at any side wall of the reader assembly 110. By way of an example, the UHF RFID reader 212 may be placed within the cavity 210 through the opening 214 via the warehouse staffer using the sliding mechanism. Additionally, the UHF RFID reader 212 may be removed from the cavity 210 through the opening 214 via the warehouse staffer as per the requirement. The reader assembly 110 may further include a base 218. The base 218 may provide structural support to the UHF RFID reader 212.

Referring now to FIG. 2C, a front perspective view 200C of the reader assembly 110 is illustrated, in accordance with some embodiments. The reader assembly 110 may further include a leaf spring 220A and a leaf spring 220B. Each leaf spring may be placed on a front wall 222 within an inner periphery of the reader assembly 110. Each leaf spring may be used to maintain the position of the UHF RFID reader 212 within the cavity 210.

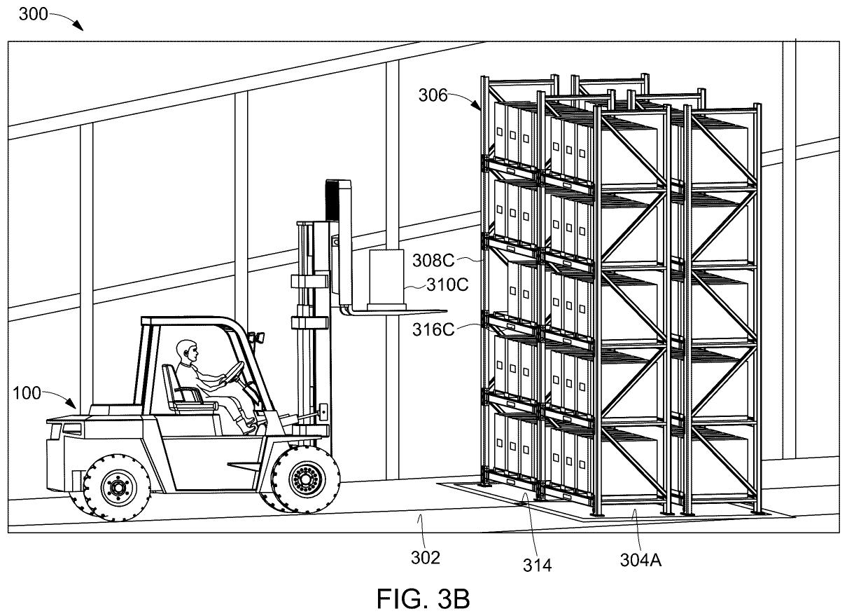

Referring now to FIGS. 3A-3B, an exemplary warehouse storage system 300 is illustrated, in accordance with some embodiments. The warehouse storage system 300 may be designed to store and retrieve material (or goods) in an efficient and accessible way. The warehouse storage system 300 may include a floor 302 that may further include a plurality of floor bays. Each floor bay of the plurality of floor bays may include a bay number, which may be a numeric value. Each of the plurality of floor bays may include a plurality of racks. Each of the plurality of racks may include a plurality of storage shelves and each shelf of the plurality of storage shelves may be assigned a shelf number, which may be a numeric value.

The floor 302 may include a floor bay 304A and a floor bay 304B. It will be apparent that the floor 302 may include more than one floor bays, however, only two floor bays are depicted for ease of explanation. The floor bay 304A may be allocated the bay number ‘B1’, while the floor bay 304B may be allocated the bay number ‘B2’. Further explanation for the warehouse storage system 300 is with reference to the floor bay 304A, which include a rack 306. The rack 306 may further include storage shelves 308A-308E, such that, each of the storage shelves 308A-308E is allocated a shelf number. The storage shelves 308A-308E may be allocated the shelf numbers S1-S5 respectively.

The warehouse storage system 300 may include objects 310A-310C. However, it will be apparent that the warehouse storage system 300 may include more than three objects. Some objects may be placed on a storage shelf, while some objects may be placed on the floor 302 of the warehouse. As is apparent from FIG. 3A, the objects 310A-310B may be priorly stored on the storage shelf 308C (i.e., the shelf number ‘S3’) and the object 310C may be placed on the floor 302. Each of the objects 310A-310C may include first passive tags 312A-312C respectively. Each of the first passive tags 312A-312C may be mapped with a package information associated with the objects 310A-310C. In the same manner, the floor bay 304A may include a second passive tag 314. The second passive tag 314 may be mapped with the bay number ‘B1’. Each of the storage shelves 308A-308E may include third passive tags 316A-316E respectively that may be further mapped with the shelf numbers S1-S5 respectively. Further explanation of the warehouse storage system 300 is with reference to the storage shelf 308C.

As depicted in FIG. 3B, the warehouse storage system 300 may include the forklift 100. It will be apparent that the warehouse storage system 300 may include more than one forklift for storing or retrieving the objects in the warehouse. By way of an example, consider a scenario where the warehouse staffer wants to store the object 310C on the storage shelf and then record the updated location of the object 310C. To this end, when the forklift 100 is picking up the pallet along with the object 310C through the forks (i.e., 108A and 108B) from the floor 302, the UHF RFID reader 212 may scan (or read) the first passive tag 312C placed on the object 310C. Upon scanning the first passive tag 312C, the UHF RFID reader 212 may send the information associated with the first passive tag 312C to the control unit. Accordingly, the control unit may identity that this information corresponds to a package information associated with the object 310C.

Further, when the forklift 100 is approaching towards the floor bay 304A to store the object 310C in the storage shelf, the UHF RFID reader 212 may scan the second passive tag 314 placed on the floor bay 304A. Upon scanning the second passive tag 314, the UHF RFID reader 212 may send the information associated with the second passive tag 314 to the control unit. Accordingly, the control unit may identify that this information corresponds to the bay number ‘B1’ of the floor bay 304A.

Now, when the forklift 100 is about to unload the object 310C in any of the storage shelves of the rack 306, the UHF RFID reader 212 may scan the third passive tag 316C and send the received information associated with the third passive tag 316C to the control unit. Further, the control unit may identify that this information corresponds to the storage shelf 308C (i.e., the shelf number ‘S3’).

Once the control unit receives the information associated with the first passive tag 312C, the second passive tag 314, and the third passive tag 316C from the UHF RFID reader 212, the control unit may record and store the current location of the object 310C, i.e., the object 310C is stored in the storage shelf ‘S3’ of the rack 306 in the bay number ‘B1.’ The control unit may send details corresponding to the current location of the object 310C to an end device (e.g., a laptop). The control unit may also render the current location of the object 310C on the end device.

In another scenario, the warehouse staffer may want to retrieve the stored object 310A from the storage shelf 308C. To this end, the control unit may initially receive instructions to retrieve the object 310A from an end device. In response, the control unit may transmit a signal to the forklift 100 that is in proximity to the current location of the object 310A. The signal may include the current location (such as, the rack 306, the bay number ‘B1’, and the storage shelf ‘S3’) of the object 310A. Further, upon receiving the signal, the forklift 100 may move towards the rack 306 in the bay number ‘B1,’ lift the forks towards the storage shelf ‘S3,’ engage with the pallet holding the object 310A and retrieve the object 310A from the storage shelf ‘S3.’

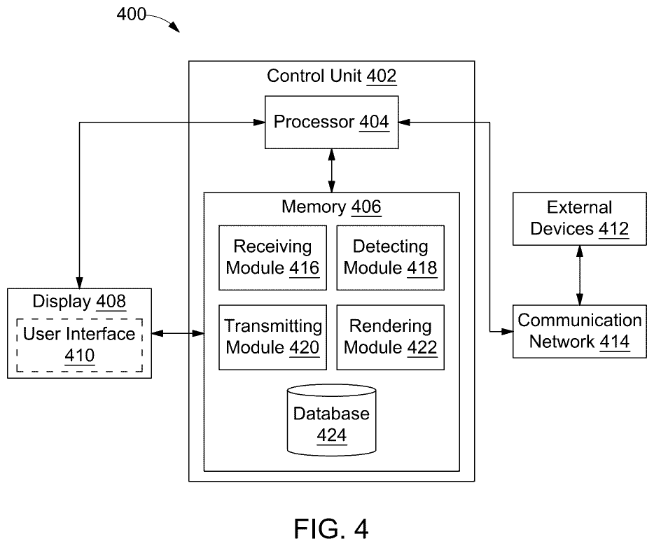

Referring now to FIG. 4, a functional block diagram of a system 400 for storing and detecting a current location of an object in a warehouse is illustrated, in accordance with some embodiments. The system 400 may include a control unit 402. The control unit 402 may be configured to detect the current location of the object in the warehouse. The control unit 402 may then store the detected current location of the object in a database. The control unit 402 may include one or more processors 404, a memory 406. The memory 406 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.). The memory 406 may include a receiving module 416, a detecting module 418, a transmitting module 420, a rendering module 422, and a database 424.The memory 406 may store instructions that, when executed by the one or more processors 404, may cause the one or more processors 404 to detect and store the current location of the object in the warehouse, in accordance with aspects of the present disclosure.

Initially, the receiving module 416 may receive information associated with a first passive tag from one or more tag readers (such as the UHF RFID reader 212). The one or more tag readers are configured to read the first passive tag in response to a forklift (such as the forklift 100) picking up an object. The first passive tag is placed on the object and is mapped with a package information associated with the object. Upon receiving the information associated with the first passive tag, the receiving module 416 may receive information associated with a second passive tag from the one or more tag readers. The one or more tag readers are configured to read the second passive tag in response to the forklift being within a predefined proximity from a floor bay associated with a plurality of storage shelves. The second passive tag is placed on the floor bay and is mapped to a bay number of the floor bay.

Upon receiving the information associated with the second passive tag, the receiving module 416 may receive information associated with a third passive tag from the one or more tag readers. The one or more tag readers are configured to read the third passive tag in response to the forklift unloading the object onto a storage shelf and is mapped to a shelf number of the storage shelf. The receiving module 416 may then send the information associated with the first passive tag, the second passive tag, and the third passive tag to the detecting module 418.

Based on the received information associated with the first passive tag, the second passive tag, and the third passive tag, the detecting module 418 may detect the current location of the object. The detecting module 418 may then store the detected current location of the object in the warehouse within the database 424. The transmitting module 420 may then transmit details corresponding to the current location of the object in the warehouse to an end device. The details corresponding to the current location, for example, may be, but is not limited to a bay number, a rack number, a shelf number, and package information associated with the object in the warehouse. The rendering module 422 may render the current location of the object in the warehouse on the end device.

The system 400 may further include a display 408. A user may interact with the system 400 via a user interface 410 accessible via the display 408. The system 400 may also include one or more external devices (or end device) 412. In some embodiments, the control unit 402 may interact with the one or more external devices 412 over a communication network 414 for sending or receiving various data. The communication network 414 may include, but is not limited to, a wireless fidelity (Wi-Fi) network, a light fidelity (Li-Fi) network, a local area network (LAN), a wide area network (WAN), a metropolitan area network (MAN), a satellite network, the internet, a fiber optic network, a coaxial cable network, an infrared (IR) network, a radio frequency (RF) network, and a combination thereof. The one or more external devices 412 may include, but may not be limited to, a remote server, a laptop, a netbook, a notebook, a smartphone, a mobile phone, a tablet, or any other computing device.

It should be noted that all such aforementioned modules 416-422 may be represented as a single module or a combination of different modules. Further, as will be appreciated by those skilled in the art, each of the modules 416-422 may reside, in whole or in parts, on one device or multiple devices in communication with each other. In some embodiments, each of the modules 416-422 may be implemented as dedicated hardware circuit comprising custom application-specific integrated circuit (ASIC) or gate arrays, off-the-shelf semiconductors such as logic chips, transistors, or other discrete components. Each of the modules 416-422 may also be implemented in a programmable hardware device such as a field programmable gate array (FPGA), programmable array logic, programmable logic device, and so forth. Alternatively, each of the modules 416-422 may be implemented in software for execution by various types of processors (e.g., processor 404). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for detecting a current location of an object in a warehouse. For example, the control unit 402, may detect the current location of the object in the warehouse, by the processes discussed herein. In particular, as will be appreciated by those of ordinary skill in the art, control logic and/or automated routines for performing the techniques and steps described herein may be implemented by the control unit 402 either by hardware, software, or combinations of hardware and software. For example, suitable code may be accessed and executed by the one or more processors on the control unit 402 to perform some or all of the techniques described herein. Similarly, application specific integrated circuits (ASICs) configured to perform some, or all of the processes described herein may be included in the one or more processors on the control unit 402.

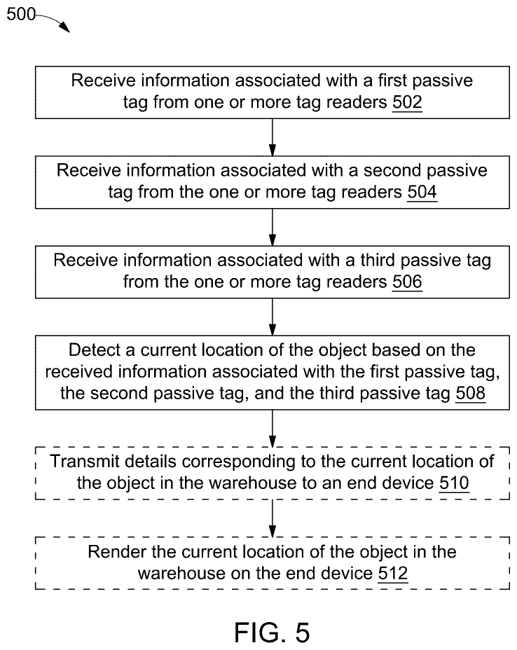

Referring now to FIG. 5, a process 500 for storing and detecting a current location of an object in a warehouse is illustrated via a flow chart, in accordance with some embodiments. FIG. 5 is explained in conjunction with FIG. 4. The process 500 may be implemented by the control unit 402 of the system 400. In some embodiments, the process 500 may include receiving information associated with a first passive tag from one or more tag readers, at step 502. The one or more tag readers are configured to read the first passive tag in response to a forklift picking up an object. The first passive tag is placed on the object and is mapped with a package information associated with the object.

Once the information associated with the first passive tag is received, the process 500 may include receiving information associated with a second passive tag from the one or more tag readers, at step 504. The one or more tag readers are configured to read the second passive tag in response to the forklift being within a predefined proximity from a floor bay associated with a plurality of storage shelves. The second passive tag is placed on the floor bay and is mapped to a bay number of the floor bay.

Once the information associated with the second passive tag is received, the process 500 may include receiving information associated with a third passive tag from the one or more tag readers, at step 506. The one or more tag readers are configured to read the third passive tag in response to the forklift unloading the object onto a storage shelf of the plurality of storage shelves. The third passive tag is placed on the storage shelf and is mapped to a shelf number of the storage shelf.

The process 500 may further include detecting a current location of the object based on the received information associated with the first passive tag, the second passive tag, and the third passive tag, at step 508. The process 500 may store the detected current location of the object in a database (such as the database 424) for future references. The process 500 may include transmitting details corresponding to the current location of the object in the warehouse to an end device, at step 510. The process 500 may include rendering the current location of the object in the warehouse to the end device, at step 512.

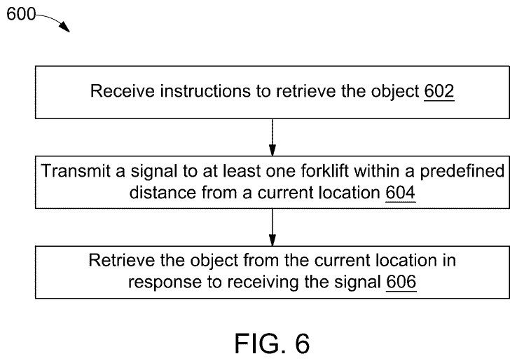

Referring now to FIG. 6, a process 600 for retrieving an object from a current location in a warehouse is illustrated via a flow chart, in accordance with some embodiments. FIG. 6 is explained in conjunction with FIG. 4 and FIG. 5. The process 600 may be implemented by the control unit 402 of the system 400. In some embodiments, the process 600 may include receiving instructions to retrieve the object, at step 602. Upon receiving the instructions, the process 600 may include transmitting a signal to at least one forklift within a predefined distance from a current location, at step 604. The process 600 may include retrieving the object from the current location in response to receiving the signal, at step 606. The current location may include information associated with a first passive tag, a second passive tag, and a third passive tag.

Various embodiments in the present disclosure provide a forklift. The disclosed forklift may include a forklift mast. The forklift mast may include a carriage assembly affixed to a first surface of the forklift mast. The carriage assembly may include one or more forks. The forklift may further include a reader assembly affixed to a second surface of the carriage assembly. The reader assembly may include a cavity positioned on a third surface of the reader assembly. The reader assembly may further include one or more tag readers detachably placed within the cavity. The one or more tag readers are configured to read one or more passive tags placed on a set of pre-defined locations in a warehouse. A reading range of the one or more tag readers is limited to a distal end of the one or more forks.

The reader assembly may further include a control unit. The control unit is configured to receive information associated with a first passive tag from the one or more tag readers. The first passive tag is placed on an object and is mapped to a package information associated with the object. The control unit may also be configured to receive information associated with a second passive tag from the one or more tag readers. The second passive tag is placed on a floor bay associated with a plurality of storage shelves and is mapped to a bay number of the floor bay. The control unit may also be configured to receive information associated with a third passive tag from the one or more tag readers. The third passive tag is placed on a storage shelf from the plurality of storage shelves and is mapped to a shelf number of the storage shelf. The control unit may also be configured to detect a current location of the object in the warehouse based on the received information associated with each of the first passive tag, the second passive tag, and the third passive tag.

Thus, the present disclosure may overcome drawbacks of conventional forklifts that may provide inaccurate location of objects in a warehouse. The present disclosure discloses a forklift that may cater to problems associated with the conventional forklift with RFID readers. The disclosed forklift may provide an accurate current location of the object in the warehouse. Further, the disclosed forklift may include a tag reader (e.g., RFID reader) which is able to read passive tags upto 2 to 3 feet in straight path only corresponding to the forks. Additionally, the disclosed forklift may use light weighted tag readers which are easy to handle and require low energy for its operation. Further, the disclosed forklift is convenient to use and cost effective.

In light of the above-mentioned advantages and the technical advancements provided by the disclosed forklifts, reader assembly for forklifts, and warehouse storage system thereof, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described forklifts, reader assembly for forklifts, and warehouse storage system thereof. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

It is intended that the disclosure and examples be considered as exemplary only, with a true scope and spirit of disclosed embodiments being indicated by the following claims.

What is claimed is:

1. A forklift comprising:
a forklift mast comprising a carriage assembly affixed to a first surface of the forklift mast, wherein the carriage assembly comprises one or more forks;
a reader assembly affixed to a second surface of the carriage assembly, wherein the reader assembly comprises:
a cavity positioned on a third surface of the reader assembly; and
one or more tag readers detachably placed within the cavity, wherein the one or more tag readers are configured to read one or more passive tags placed on a set of pre-defined locations in a warehouse, wherein a reading range of the one or more tag readers is limited to a distal end of the one or more forks; and
a control unit configured to:
receive information associated with a first passive tag from the one or more tag readers, wherein the first passive tag is placed on an object and is mapped to a package information associated with the object;
receive information associated with a second passive tag from the one or more tag readers, wherein the second passive tag is placed on a floor bay associated with a plurality of storage shelves and is mapped to a bay number of the floor bay;
receive information associated with a third passive tag from the one or more tag readers, wherein the third passive tag is placed on a storage shelf of the plurality of storage shelves and is mapped to a shelf number of the storage shelf; and
detect a current location of the object in the warehouse based on the received information associated with each of the first passive tag, the second passive tag, and the third passive tag.

2. The forklift of claim 1, wherein the object is one of a pallet or a package placed on the pallet.

3. The forklift of claim 1, further comprising:
a charger assembly detachably fixed to a fourth surface of the carriage assembly, wherein the charger assembly comprises:
a plate; and
a wireless charger mounted on the plate, wherein the wireless charger is configured to charge the one or more tag readers in response to the one or more tag readers being within a predefined proximity of the wireless charger.

4. The forklift of claim 1, wherein a unique identifier (ID) associated with the first passive tag comprises a first alphanumeric code uniquely linked with objects in the warehouse, a unique ID associated with the second passive tag comprises a second alphanumeric code uniquely linked with floor bays in the warehouse, and a unique ID associated with the third passive tag comprises a third alphanumeric code uniquely linked with shelves in the warehouse.

5. The forklift of claim 1, wherein the one or more tag readers are communicatively coupled with an end device, and wherein the one or more tag readers are further configured to send a notification to the end device, wherein the notification comprises:
details of a floor bay, a rack number, and a shelf number associated with the object in the warehouse; and
package information associated with the object.

6. A reader assembly for forklifts comprising:
a cavity positioned on a first surface of the reader assembly;
one or more tag readers detachably placed within the cavity, wherein the one or more tag readers are configured to read one or more passive tags placed on a set of pre-defined locations in a warehouse, wherein a reading range of the one or more tag readers is limited to a predefined distance; and2
a control unit configured to:
receive information associated with a first passive tag from the one or more tag readers, wherein the first passive tag is placed on an object and is mapped to a package information associated with the object;
receive information associated with a second passive tag from the one or more tag readers, wherein the second passive tag is placed on a floor bay associated with a plurality of storage shelves and is mapped to a bay number of the floor bay;
receive information associated with a third passive tag from the one or more tag readers, wherein the third passive tag is placed on a storage shelf of the plurality of storage shelves and is mapped to a shelf number of the storage shelf; and
detect a current location of the object in the warehouse based on the received information associated with each of the first passive tag, the second passive tag, and the third passive tag.

7. The reader assembly of claim 6, wherein the object is one of a pallet or a package placed on the pallet.

8. The reader assembly of claim 6, wherein a unique identifier (ID) associated with the first passive tag comprises a first alphanumeric code uniquely linked with objects in the warehouse, a unique ID associated with the second passive tag comprises a second alphanumeric code uniquely linked with floor bays in the warehouse, and a unique ID associated with the third passive tag comprises a third alphanumeric code uniquely linked with shelves in the warehouse.

9. The reader assembly of claim 6, wherein the one or more tag readers are communicatively coupled with an end device, and wherein the one or more tag readers are further configured to send a notification to the end device, wherein the notification comprises:
details of a floor bay, a rack number, and a shelf number associated with the object in the warehouse; and
package information associated with the object.

10. A warehouse storage system comprising:
a floor comprising a plurality of floor bays, wherein each of the plurality floor bays comprise a plurality of racks, and wherein each of the plurality of racks comprise a plurality of storage shelves;
a plurality of forklifts, wherein each of the plurality of forklifts comprises:
a forklift mast comprising a carriage assembly affixed to a first surface of the forklift mast, wherein the carriage assembly comprises one or more forks; and
a reader assembly affixed to a second surface of the carriage assembly, wherein the reader assembly comprises:
a cavity positioned on a third surface of the reader assembly; and
one or more tag readers detachably placed within the cavity, wherein the one or more tag readers are configured to read one or more passive tags placed on a set of pre-defined locations in a warehouse, wherein a reading range of the one or more tag readers is limited to a distal end of the one or more forks; and
a control unit configured to:
receive information associated with a first passive tag from the one or more tag readers, wherein the first passive tag is placed on an object and is mapped to a package information associated with the object;
receive information associated with a second passive tag from the one or more tag readers, wherein the second passive tag is placed on a floor bay associated with a plurality of the storage shelves and is mapped to a bay number of the floor bay;
receive information associated with a third passive tag from the one or more tag readers, wherein the third passive tag is placed on a storage shelf from the plurality of storage shelves and is mapped to a shelf number of the storage shelf; and
detect a current location of the object in the warehouse based on the received information associated with the first passive tag, the second passive tag, and the third passive tag.

11. The warehouse storage system of claim 10, wherein the object is one of a pallet or a package.

12. The warehouse storage system of claim 10, wherein the forklift further comprises:
a charger assembly detachably fixed to a fourth surface of the carriage assembly, wherein the charger assembly comprises:
a plate; and
a wireless charger mounted on the plate, wherein the wireless charger is configured to charge the one or more tag readers in response to the one or more tag readers being within a predefined proximity from the wireless charger.

13. The warehouse storage system of claim 10, wherein a unique identifier (ID) associated with the first passive tag comprises a first alphanumeric code uniquely linked with objects in the warehouse, a unique ID associated with the second passive tag comprises a second alphanumeric code uniquely linked with floor bays in the warehouse, and a unique ID associated with the third passive tag comprises a third alphanumeric code uniquely linked with shelves in the warehouse.

14. The warehouse storage system of claim 10, wherein the one or more tag readers are communicatively coupled with an end-device, and wherein the one or more tag readers are further configured to send a notification to the end-device, wherein the notification comprises:
details of a floor bay, a rack number, and a shelf number associated with the object in the warehouse; and
package information associated with the object.

15. A method for detecting a current location of an object in a warehouse, the method comprising:
receiving, by a control unit, information associated with a first passive tag information from one or more tag readers, wherein the one or more tag readers are configured to read the first passive tag in response to a forklift picking-up an object, wherein the first passive tag is placed on the object and is mapped with a package information associated with the object;
receiving, by the control unit, information associated with a second passive tag from the one or more tag readers, wherein the one or more tag readers are configured to read the second passive tag in response to the forklift being within a predefined proximity from a floor bay associated with a plurality of storage shelves, wherein the second passive tag is placed on the floor bay and is mapped to a bay number of the floor bay;
receiving, by the control unit, information associated with a third passive tag from the one or more tag readers, wherein the one or more tag readers are configured to read the third passive tag in response to the forklift unloading the object onto a storage shelf of the plurality of storage shelves, wherein the third passive tag is placed on the storage shelf and is mapped to a shelf number of the storage shelf; and
detecting a current location of the object based on the received information associated with the first passive tag, the second passive tag, and the third passive tag.

16. The method of claim 15, further comprising storing the detected current location of the object in the warehouse within a database.

17. The method of claim 15, further comprising transmitting details corresponding to the current location of the object in the warehouse to an end device.

18. The method of claim 17, further comprising rendering the current location of the object in the warehouse on the end device.

19. The method of claim 15, further comprising:
receiving, by the control unit, instructions to retrieve the object; and
transmitting, by the control unit, a signal to at least one forklift withing a predefined distance from the current location, wherein the signal comprises the current location of the object.

20. The method of claim 19, further comprising retrieving, by the forklift, the object from the current location in response to receiving the signal, wherein the current location comprises information associated with the first passive tag, the second passive tag, and the third passive tag.
